(19) United States
(12) Patent Application Publication
(10) Pub. No.: US 2002/0169965 A1
(43) Pub. Date: Nov. 14, 2002

(54) Clearance-based method for dynamically configuring encryption strength

(76) Inventors: Douglas LaVell Hale, Orem, UT (US); Peter Kendrick Boucher, Orem, UT (US); Mark Gordon Gayman, Orem, UT (US)

Correspondence Address: SAWYER LAW GROUP LLP, P.O. Box 51418, Palo Alto, CA, 94303, US

(21) Appl. No.: 09/851,724

(22) Filed: May 8, 2001

(51) Int. Cl. H04K 1/00

(52) U.S. Cl. 713/182

(57) ABSTRACT

The method for configuring encryption strengths for data includes: providing a piece of the data with a sensitivity level; authenticating a remote user with a clearance level for accessing the data; selecting an encryption strength for the piece of the data based on the clearance level of the remote user, if the clearance level of the remote user allows access to the piece of the data with the sensitivity level; encrypting the piece of the data; and providing access to the encrypted piece of the data to the remote user. Remote users have varying levels of clearance to access data. Data is assigned varying sensitivity levels. Each clearance level allows the remote user to access data at that sensitivity level or below. The strength of the data encryption is based upon the remote user's clearance level or a requested session sensitivity level. Access control to data is thus more flexible.

### FIELD OF THE INVENTION

The present invention relates to computer systems, and more particularly, to data access in computer systems.

### BACKGROUND OF THE INVENTION

Certain computer systems in the industry require the encryption of data. For example, banking through the Internet typically requires a remote user to have a browser which supports the standard 128-bit SSL cipher suite for the encryption of data. However, with conventional systems, all of the data is either encrypted or not and with the same encryption strength. This is inflexible.

Accordingly, there exists a need for a method for dynamically configuring an encryption strength for data. The present invention addresses such a need.

### SUMMARY OF THE INVENTION

The method for configuring encryption strengths for data includes: providing a piece of the data with a sensitivity level; authenticating a remote user with a clearance level for accessing the data; selecting an encryption strength for the piece of the data based on the clearance level of the remote user, if the clearance level of the remote user allows access to the piece of the data with the sensitivity level; encrypting the piece of the data; and providing access to the encrypted piece of the data to the remote user. Remote users have varying levels of clearance to access data. Data is assigned varying sensitivity levels. Each clearance level allows the remote user to access data at that sensitivity level or below. The strength of the data encryption is based upon the remote user's clearance level or a requested session sensitivity level (a temporarily-lowered clearance that lasts as long as the current session). Access control to data is thus more flexible.

### BRIEF DESCRIPTION OF THE FIGURES

FIG. 1 illustrates a preferred embodiment of a system which utilizes the method for dynamically configuring an encryption strength for data in accordance with the present invention.

FIG. 2 is a flowchart illustrating a preferred embodiment of the method for dynamically configuring an encryption strength for data in accordance with the present invention.

FIG. 3 is a flowchart illustrating in more detail the preferred embodiment of the method for dynamically configuring an encryption strength for data in accordance with the present invention.

FIG. 4 is a flowchart illustrating the method for dynamically configuring an encryption strength for data in accordance with the present invention, with the remote user requesting a session sensitivity level.

### DETAILED DESCRIPTION

The present invention provides a method for dynamically configuring an encryption strength for data. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

The method in accordance with the present invention provides remote users with varying levels of clearance to access data. Data in the system is assigned varying sensitivity levels. Each level of clearance allows the remote user to access data of a certain sensitivity level and below. In the preferred embodiment, the sensitivity level of data is assigned by the local user. The “local user” is the user which owns the data. The “remote user” is the user who is seeking access to the data. “Sensitivity level” refers to a representation of the amount of damage that would be done to the local user if an unauthorized user gains access to the data. The remote user provides his clearance level for accessing data. Before the data is provided to the remote user, it is encrypted. The strength of the encryption of the data is based upon the remote user's clearance level or a requested session sensitivity level.

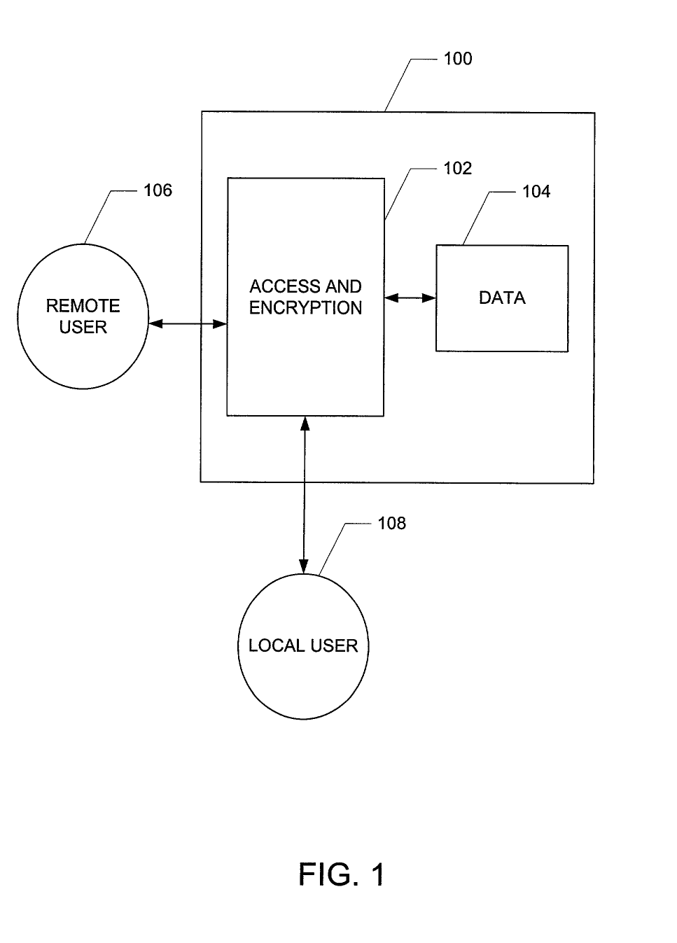

To more particularly describe the features of the present invention, please refer to FIGS. 1 through 4 in conjunction with the discussion below.

FIG. 1 illustrates a preferred embodiment of a system which utilizes the method for dynamically configuring an encryption strength for data in accordance with the present invention. The system 100 includes an access and encryption software 102 which interfaces with a piece of data 104, the remote user 106, and the local user 108. The remote user 106 has been assigned a clearance level, and the pieces of data 104 has been assigned a sensitivity level by the local user 108.

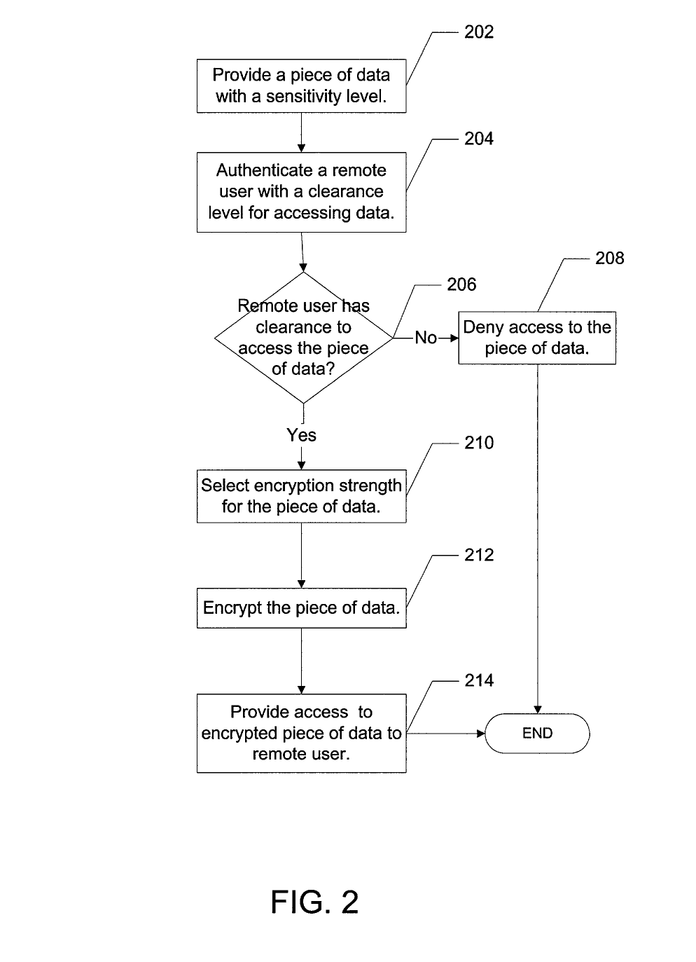

FIG. 2 is a flowchart illustrating a preferred embodiment of the method for dynamically configuring an encryption strength for data in accordance with the present invention. First, a piece of data 104 with a sensitivity level is provided, via step 202. Next, the remote user is then authenticated, via step 204. Next, it is determined if the remote user 106 has clearance to access the piece of data 104. The piece of data 104 has been assigned a certain sensitivity level by the local user 108. If the remote user 106 does not have clearance to access the piece of data 104 of that sensitivity level, then access to the piece of data 104 is denied, via step 208. If the remote user 106 has clearance to access the piece of data 104 of that sensitivity level, then an encryption strength for the piece of data 104 is selected, via step 210. The encryption strength determines the cipher suite to be used. The piece of data 104 is encrypted with the cipher suite with the determined encryption strength, via step 212. The remote user 106 is then provided access to the encrypted piece of data, via step 214.

In the preferred embodiment, the encryption strength, and thus the cipher suite to be used, is based upon the remote user's clearance level. The local user 108 can configure the access and encryption software 102 to specify which cipher-suites are appropriate for each clearance level. For example, assume that the clearance levels range from “0” to “10”, with “0” being the lowest clearance, i.e., access only to data intended for public consumption. The following is an example set of cipher suites assigned to the clearance levels:

Level 0: no encryption, with 32-bit CRC error-detection

Levels 1-3: 40-bit RC4, 40-bit RC2, or 56-bit DES, with HMAC

Levels 4-7: 128-bit RC5, or 128-bit Blowfish, with RSA/MD5

Levels 8-10: 3-key 3DES, or 256-bit Rijndael, with RSA/SHA1

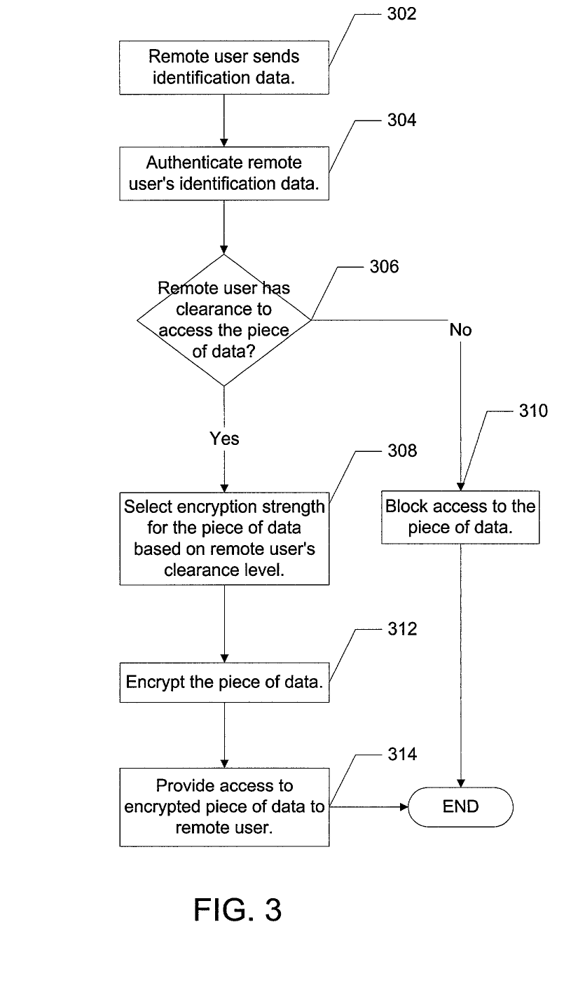

FIG. 3 is a flowchart illustrating in more detail the preferred embodiment of the method for dynamically configuring an encryption strength for data in accordance with the present invention. First, the remote user 106 sends his identification data, via step 302, which is then authenticated, via step 304. When the remote user 106 requests access to a piece of data 104 in the system 100, it is determined if the remote user 106 has clearance to access the piece of data 104, via step 306. If the remote user 106 does not have clearance to access the piece of data 104, then access to the piece of data 104 is blocked, via step 310. If the remote user 106 has clearance to access the piece of data 104, then an encryption strength for the piece of data 104 is selected based on the remote user's clearance level, via step 308. The piece of data 104 is then encrypted, via step 312, and access to the encrypted piece of data provided to the remote user 106, via step 314. Steps 306-314 are repeated for each piece of data to which the remote user 106 requests access.

Although the preferred embodiment handling the encrypting of data as described above, one of ordinary skill in the art will understand that other methods of encrypting data may be used without departing from the spirit and scope of the present invention.

An additional feature which may be provided with the method in accordance with the present invention is to allow the remote user 106 to request a certain sensitivity level for the current session, or “session sensitivity level”. The session sensitivity level must be at or below the remote user's assigned clearance level. This may be useful in certain situations, such as when the remote user 106 is using a public terminal and do not wish any data above a certain sensitivity level to be downloaded into the public terminal.

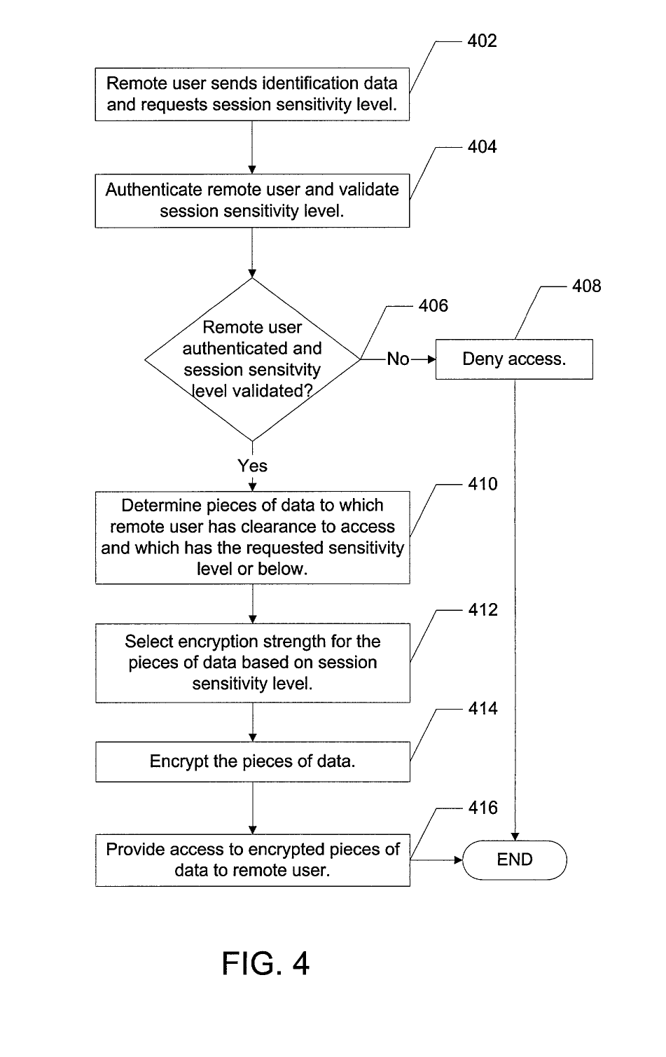

FIG. 4 is a flowchart illustrating the method for dynamically configuring an encryption strength for data in accordance with the present invention, with the remote user requesting a session sensitivity level. First, the remote user 106 sends identification data and requests a session sensitivity level, via step 402. Next, the remote user's identification data is authenticated, and the session sensitivity level is validated, via step 404. The session sensitivity level is valid if the remote user's clearance allows him to access data with sensitivity levels at or below the requested session sensitivity level. If the remote user 106 is not authenticated or the session sensitivity level is not valid, via step 406, then access to data in the system 100 is denied, via step 408. If the remote user 106 is authenticated and the session sensitivity level is valid, via step 406, then it is determined which pieces of data to which the remote user 106 has clearance to access and which has the requested session sensitivity level or below, via step 410. The encryption strength for the pieces of data is then selected based on the session sensitivity level, via step 412. The cipher suites for each session sensitivity level can be assigned in the same manner as for the clearance level, described above. Other methods for assigning the cipher suites for the session sensitivity levels can also be used without departing from the spirit and scope of the present invention. Once the cipher suite for the session sensitivity level is selected, the pieces of data are encrypted, via step 414. The remote user 106 is then provided access to the encrypted pieces of data, via step 416.

Another feature which may be added to the method for dynamically configuring an encryption strength for data in accordance with the present invention is allowing other facts to be considered in selecting the encryption strength. For example, the security rating of the output line onto which the data will be provided to the remote user 106 may be taken into account in selecting the encryption strength or cipher suite for a particular clearance or session sensitivity level. For example, data that is to be sent over the Internet, or some other public medium, is to be assigned a stronger encryption than data that is to be sent over a leased line, or some other non-public medium. Similarly, data that is to be sent over a leased line, or some other non-public but non-physically-protected medium, is assigned a stronger encryption than data that is to be sent to another host on the same local area network, or some other physically-protected medium.

Another factor is the sensitivity level of the requested data. For performance enhancement, low-sensitivity data can be encrypted with weaker (faster) encryption even if the remote user has a higher clearance level. Other factors may be considered in the method in accordance with the present invention without departing from the spirit and scope of the present invention.

Any combination of these factors may be considered in selecting the encryption strength. In the preferred embodiment, the degree to which each of these factors is taken into consideration may be configuration by the local user 108.

Although the preferred embodiment selects the encryption strength as described above, one of ordinary skill in the art will understand that other methods of selecting the encryption strength may be used without departing from the spirit and scope of the present invention.

A method for dynamically configuring an encryption strength for data has been disclosed. The method provides remote users with varying levels of clearance to access data. Data in the system is assigned varying sensitivity levels. Each level of clearance allows the remote user to access data of a certain sensitivity level or below. The remote user is assigned a clearance level by the local user. Before the data is provided to the remote user, it is encrypted. The strength of the encryption of the data is based upon the remote user's clearance level or a requested session sensitivity level. In this manner, access control to data is more flexible.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for configuring encryption strengths for data, comprising the steps of:
(a) providing a piece of the data with a sensitivity level;
(b) authenticating a remote user with a clearance level for accessing the data;
(c) selecting an encryption strength for the piece of the data based on the clearance level of the remote user, if the clearance level of the remote user allows access to the piece of the data with the sensitivity level;
(d) encrypting the piece of the data; and
(e) providing access to the encrypted piece of the data to the remote user.

2. The method of claim 1, wherein the providing step (a) comprises:
(a1) providing the data, wherein each piece of the data has one of a plurality of sensitivity levels.

3. The method of claim 1, wherein the authenticating step (b) comprises:
(b1) receiving identification data for the remote user;
(b2) authenticating the identification data of the remote user; and
(b3) verifying that the remote user has been assigned the clearance level for accessing the data.

4. The method of claim 1, wherein the selecting step (c) comprises:
(c1) receiving a request from the remote user for access to the piece of data;
(c2) determining if the clearance level of the remote user allows access to the piece of data with the sensitivity level; and
(c3) selecting an encryption strength for the piece of data based on the clearance level of the remote user, if the clearance level of the remote user allows access to the piece of data with the sensitivity level.

5. The method of claim 1, wherein the authenticating step (b) comprises:
(b1) receiving identification data for the remote user and a request for a session sensitivity level;
(b2) authenticating the identification data;
(b3) verifying that the remote user has been assigned the clearance level for accessing the data; and
(b4) validating the session sensitivity level.

6. The method of claim 5, wherein the validating step (b4) comprises:
(b4i) determining if the session sensitivity level allows the remote user to access pieces of data with sensitivity levels at or below the clearance level for the remote user.

7. The method of claim 1, wherein the selecting step (c) comprises:
(c1) determining pieces of data with sensitivity levels at or below the session sensitivity level to which the clearance level allows the remote user to access; and
(c2) selecting an encryption strength for the pieces of data based on the session sensitivity level.

8. The method of claim 1, wherein the selecting of the encryption strength for the piece of the data is also based on the sensitivity level of the piece of the data.

9. The method of claim 1, wherein the selecting of the encryption strength for the piece of the data is also based on a security rating of an output line onto which the encrypted piece of the data will be provided to the remote user.

10. The method of claim 1, further comprising:
(f) blocking access to pieces of data to which the clearance level does not allow the remote user to access.

11. A method for configuring encryption strengths for data, comprising the steps of:
(a) providing a piece of the data with a sensitivity level;
(b) authenticating a remote user with a clearance level for accessing the data;
(c) receiving a request from the remote user for access to the piece of data;
(d) determining if the clearance level of the remote user allows access to the piece of data with the sensitivity level;
(e) selecting an encryption strength for the piece of data based on the clearance level of the remote user, if the clearance level of the remote user allows access to the piece of data with the sensitivity level;
(f) encrypting the piece of the data; and
(g) providing access to the encrypted piece of the data to the remote user.

12. The method of claim 11, wherein the selecting of the encryption strength for the piece of the data is also based on the sensitivity level of the piece of the data.

13. The method of claim 11, wherein the selecting of the encryption strength for the piece of the data is also based on a security rating of an output line onto which the encrypted piece of the data will be provided to the remote user.

14. The method of claim 11, wherein the selecting of the encryption strength for the piece of the data is also based on a session sensitivity level.

15. A method for configuring encryption strengths for data, comprising the steps of:
(a) providing the data, wherein each piece of the data has one of a plurality of sensitivity levels;
(b) receiving a clearance level assigned to a remote user for accessing the data and a request for a session sensitivity level;
(c) authenticating the remote user and validating the session sensitivity level;
(d) determining pieces of the data with sensitivity levels at or below the session sensitivity level to which the clearance level allows the remote user to access; and
(e) selecting an encryption strength for the pieces of the data based on the session sensitivity level;
(f) encrypting the pieces of the data; and
(g) providing access to the encrypted pieces of the data to the remote user.

16. The method of claim 15, wherein the authenticating step (c) comprises:
(c1) determining if the session sensitivity level for the remote user allows the remote user to access pieces of data with sensitivity levels at or below the clearance level for the remote user.

17. The method of claim 15, wherein the selecting of the encryption strength for the pieces of the data is also based on the clearance level of the remote user.

18. The method of claim 15, wherein the selecting of the encryption strength for the pieces of the data is also based on the sensitivity level of each piece of the data.

19. The method of claim 15, wherein the selecting of the encryption strength for the pieces of the data is also based on a security rating of an output line onto which the encrypted pieces of the data will be provided to the remote user.

20. A computer readable medium with program instructions for configuring encryption strengths for data, comprising the instructions for:
(a) providing a piece of the data with a sensitivity level;
(b) authenticating a remote user with a clearance level for accessing the data;
(c) selecting an encryption strength for the piece of the data based on the clearance level of the remote user, if the clearance level of the remote user allows access to the piece of the data with the sensitivity level;
(d) encrypting the piece of the data; and
(e) providing access to the encrypted piece of the data to the remote user.

21. The medium of claim 20, wherein the providing instruction (a) comprises instructions for:
(a1) providing the data, wherein each piece of the data has one of a plurality of sensitivity levels.

22. The medium of claim 20, wherein the authenticating instruction (b) comprises instructions for:
(b1) receiving identification data for the remote user;
(b2) authenticating the identification data of the remote user; and
(b3) verifying that the remote user has been assigned the clearance level for accessing the data.

23. The medium of claim 20, wherein the selecting instruction (c) comprises instructions for:
(c1) receiving a request from the remote user for access to the piece of data;
(c2) determining if the clearance level of the remote user allows access to the piece of data with the sensitivity level; and
(c3) selecting an encryption strength for the piece of data based on the clearance level of the remote user, if the clearance level of the remote user allows access to the piece of data with the sensitivity level.

24. The medium of claim 20, wherein the authenticating instruction (b) comprises instructions for:
(b1) receiving identification data for the remote user and a request for a session sensitivity level;
(b2) authenticating the identification data and validating the session sensitivity level;
(b3) verifying that the remote user has been assigned the clearance level for accessing the data; and
(b4) validating the session sensitivity level.

25. The medium of claim 24, wherein the validating instruction (b2) comprises instructions for:
(b4i) determining if the session sensitivity level allows the remote user to access pieces of data with sensitivity levels at or below the clearance level for the remote user.

26. The medium of claim 20, wherein the selecting instruction (c) comprises instructions for:
(c1) determining pieces of data with sensitivity levels at or below the session sensitivity level to which the clearance level allows the remote user to access; and
(c2) selecting an encryption strength for the pieces of data based on the session sensitivity level.

27. The medium of claim 20, wherein the selecting of the encryption strength for the piece of the data is also based on the sensitivity level of the piece of the data.

28. The medium of claim 20, wherein the selecting of the encryption strength for the piece of the data is also based on a security rating of an output line onto which the encrypted piece of the data will be provided to the remote user.

29. The medium of claim 20, further comprising instructions for:
(f) blocking access to pieces of data to which the clearance level does not allow the remote user to access.

30. A computer readable medium with program instructions for configuring encryption strengths for data, comprising the instructions for:
(a) providing a piece of the data with a sensitivity level;
(b) authenticating a remote user with a clearance level for accessing the data;
(c) receiving a request from the remote user for access to the piece of data;
(d) determining if the clearance level of the remote user allows access to the piece of data with the sensitivity level;
(e) selecting an encryption strength for the piece of data based on the clearance level of the remote user, if the clearance level of the remote user allows access to the piece of data with the sensitivity level;
(f) encrypting the piece of the data; and
(g) providing access to the encrypted piece of the data to the remote user.

31. The medium of claim 30, wherein the selecting of the encryption strength for the piece of the data is also based on the sensitivity level of the piece of the data.

32. The medium of claim 30, wherein the selecting of the encryption strength for the piece of the data is also based on a security rating of an output line onto which the encrypted piece of the data will be provided to the remote user.

33. The medium of claim 30, wherein the selecting of the encryption strength for the piece of the data is also based on a session sensitivity level.

34. A computer readable medium with program instructions for configuring encryption strengths for data, comprising the instructions for:
(a) providing the data, wherein each piece of the data has one of a plurality of sensitivity levels;
(b) receiving a clearance level assigned to a remote user for accessing the data and a request for a session sensitivity level;
(c) authenticating the remote user and validating the session sensitivity level;
(d) determining pieces of the data with sensitivity levels at or below the session sensitivity level to which the clearance level allows the remote user to access; and
(e) selecting an encryption strength for the pieces of the data based on the session sensitivity level;
(f) encrypting the pieces of the data; and
(g) providing access to the encrypted pieces of the data to the remote user.

35. The medium of claim 34, wherein the authenticating instruction (c) comprises instructions for:
(c1) determining if the session sensitivity level allows the remote user to access pieces of data with sensitivity levels at or below the clearance level for the remote user.

36. The medium of claim 34, wherein the selecting of the encryption strength for the pieces of the data is also based on the clearance level of the remote user.

37. The medium of claim 34, wherein the selecting of the encryption strength for the pieces of the data is also based on the sensitivity level of each piece of the data.

38. The medium of claim 34, wherein the selecting of the encryption strength for the pieces of the data is also based on a security rating of an output line onto which the encrypted pieces of the data will be provided to the remote user.
